(19) United States
(12) Patent Application Publication
(10) Pub. No.: US 2009/0225050 A1
(43) Pub. Date: Sep. 10, 2009

(54) Touch panel, liquid crystal display apparatus, and method for manufacturing thereof

(75) Inventor: Naohito Toyomaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 12/379,682

(22) Filed: Feb. 26, 2009

(30) Foreign Application Priority Data
Mar. 4, 2008 (JP) 2008-053330

(51) Int. Cl. G06F 3/041

(52) U.S. Cl. 345/173

(57) ABSTRACT

The present invention is configured such that a touch panel has a dot spacer that is disposed on an inner transparent conductive film and that is disposed on a display surface of a liquid crystal display panel via an air layer. An another dot spacer is disposed on a surface of touch panel opposite to the display surface of the liquid crystal display panel at a position which does not overlap with the dot spacer within a predetermined view angle range on the display surface.

### BACKGROUND OF THE INVENTION

1. Field of the Invention

The present invention relates to a touch panel to be disposed on a liquid crystal display panel via an air layer, a liquid crystal display apparatus, and a method for manufacturing thereof.

2. Description of the Related Art

A liquid crystal display apparatus equipped with a touch panel is used in various fields such as POS (Point of Sales) terminals, ATMs (Automatic Teller Machines), ticket machines and car audio equipment. Moreover, a liquid crystal display apparatus equipped with a touch panel is utilized in wide fields such as PDAs (Personal Data assistants) and smartphones which also provide a telephone function. In such a kind of liquid crystal display apparatus, the load imposed by an input plane, which also serves as a display surface, includes load caused by an input operation. Further, in the case of a liquid crystal display apparatus which has an enhanced portability, there is for example a load imposed while it is transported in a bag or carried in the pocket of clothes, and the magnitude of the load as well as the factor to cause the load spans a wide spectrum. Furthermore, due to the characteristics of the application and structure of a liquid crystal display apparatus having a touch panel, a component to be disposed inside the liquid crystal display apparatus is subject to strict dimensional requirements especially when used in a liquid crystal display apparatus that has high percentage of the component occupying the volume of the liquid crystal display, and therefore thickness reduction and weight reduction are necessary conditions for the component.

FIG. 1 shows a sectional view of a liquid crystal display apparatus relating to the present invention. As shown in FIG. 1, liquid crystal display panel 110 is configured such that TFT substrate 111 disposed with a TFT (Thin Film Transistor) pattern for driving a liquid crystal thereon and color filter substrate 112 formed with an opposing electrode layer thereon are disposed with a liquid crystal layer interposed therebetween. TFT substrate 111 and color filter 112 are attached with polarizing plate 113, 114 respectively. Touch panel 120 is of an analog resistive film type in which upper substrate 121 which is formed on one side with a transparent conductive film as a position detection electrode, and lower substrate 122 which is similarly formed with a transparent conductive film are placed such that the transparent conductive films of each substrate 121, 122 are opposite each other and the substrates are held by a double-faced adhesive agent provided on the peripheral edge part of each substrate 121, 122.

Liquid crystal display panel 110 and touch panel 120 are placed directly on chassis frame 131 or placed in such a way that a double-faced adhesive agent which also has a spacer function to maintain a fixed gap is provided on the peripheral edge part of each panel 110, 120. Further, there is provided air layer 140 having a predetermined thickness between liquid crystal display panel 110 and touch panel 120.

However, in a liquid crystal display apparatus, although it has air layer 140, due to the effects such as a load to touch panel 120 during input operation, warping of touch panel 120, warping of liquid crystal display panel 110, deformation of touch panel 120 and deformation of liquid crystal display panel 110 caused by other loads, and both deformations of those panels 110, 120, there may be a case in which lower substrate 122 of touch panel 120 and polarizing plate 113 disposed on top of liquid crystal display panel 110 come abnormally close to each other. In such a case, in the liquid crystal display apparatus, interference fringes take place and a problem arises in that the display condition is impaired by the interference fringes. Further, there is also a case in which lower substrate 122 of touch panel 120 and polarizing plate 113 of liquid crystal display panel 110 come into contact and stick to each other resulting in a problem in which normal functions such as operation of the liquid crystal display apparatus cannot be performed.

As related art for solving such problems, Japanese Utility Model Application Laid-Open No. 03-020832 is disclosed, and a typical configuration example thereof is shown in FIG. 2. In this configuration example, it is configured such that dot-form spacer 124 (hereinafter referred as dot spacer 124) is disposed within touch panel 120, and another dot spacer 144 is disposed on lower substrate 122 of touch panel 120 so as to be placed at the same position with dot spacer 124. Since, with this configuration, the surface of lower substrate 122 of touch panel 120 and the display surface of liquid crystal display panel 110 are kept at a fixed distance, it is possible to achieve the effect of preventing the occurrence of interference fringes.

However, in this configuration, dot spacer 214 in touch panel 120 and dot-spacer 144 provided on lower substrate 122 are disposed at the same position. As the result of this, the transmittance of a portion in which dot-spacers 124 and 144 are overlapped is given by T=T1×T2×T3, when letting the transmittance of a position without the dot-spacer be T1, that of dot spacer 124 of touch panel 120 be T2, and that of dot-spacer 144 in air layer 140 be T3 as shown in FIG. 3. Therefore, transmittance T of a portion in which dot-spacers 124 and 144 overlap with each other is inevitably smaller than transmittance T1 in the position where there is no dot-spacer, and smaller than transmittance T2 in the case in which the dot-spacer is existent in either in touch panel 120 or in air layer 140, and smaller than transmittance T3.

For this reason, when the portion in which dot-spacer 124 and dot-spacer 144 overlap with each other increases, there is a risk of degradation of display performance such that the existence of dot-spacer 124, 144 is visually recognizable, or dot-spacer 124, 144 is misrecognized as a foreign object in the display panel 110. Therefore, this configuration has a problem in that it is difficult to concurrently prevent the occurrence of interference fringes and to maintain display performance.

Further, in recent years, as shown in FIG. 4, there is also disclosed a configuration in which instead of providing an air layer between touch panel 120 and liquid crystal display panel 110, touch panel 120, on which adhesive material 151 is provided in advance, is directly pasted to the surface of liquid crystal display panel 110. However, this configuration has a problem in that the manufacturing cost of a touch panel is high, the yield of a liquid crystal display apparatus in the manufacturing process is low, the initial cost for such equipment investment is high, and the load during the input operation is likely to propagate to the surface of the liquid crystal display panel. Therefore, in this configuration, there are many problems such as that since display irregularities occur when the touch panel is pressed, it is necessary, as a countermeasure thereof, to improve the structure of the liquid crystal display panel.

Further, there is a liquid crystal display apparatus having a structure in which instead of using the above described adhesive material, a transparent material such as a resin material is coated on the entire display surface of the liquid crystal display panel and thereafter a touch panel is mounted onto the liquid crystal display panel thereafter curing the resin material. However, in this configuration as well, there are many problems such as high manufacturing cost, low reliability and the like. Therefore, in a liquid crystal display apparatus, in which as the result of taking manufacturing cost and reliability into account, a touch panel in which a structure provided with an air layer is adopted and a touch panel of this structure is mounted, as disclosed in Japanese Patent Laid-Open No. 63-26624 and Japanese Patent Laid-Open No. 2001-51262, in order to prevent the sticking or the occurrence of interference fringes when the touch panel and the liquid crystal display panel come into contact, there is an example which adopts a configuration in which surface roughening is applied to mutually opposing surfaces such as when, for example, a microscopic asperity is provided on the display surface of the liquid crystal display panel or a film processed to have an equivalent asperity is pasted thereto so that the surface of the liquid crystal display panel or the surface of the lower substrate of the touch panel is not a smooth surface.

In such a configuration, although the sticking between the liquid crystal display panel and the touch panel and the occurrence of interference fringes may be solved, it is thought that the image quality performance and display performance of a liquid crystal display apparatus will be affected since degradations in display visibility and optical characteristics will be caused. When a sample in which anti-glare processing is applied on the surface of the polarizing plate provided on the color filter substrate making up a liquid crystal display panel is actually fabricated and used, a problem occurs in which fine size characters displayed on the liquid crystal display apparatus are blurred and also in which degradation in contrast occurs in the result of an optical measurement, and in which the level at which actual use becomes possible is not been reached.

On the other hand, to solve the above described problems, conventionally, it is necessary to set the thickness of the air layer to a sufficient amount, for example, from about 0.15 mm to 1.0 mm in order that the touch panel and the liquid crystal display panel will not readily come into contact with each other taking into consideration that the warping of the touch panel may take place for example in an amount of about 0.1 mm, and that the liquid crystal display panel or the touch panel may deform due to a load which is imposed during input operation of the touch panel by a specifically designed input pen or by fingers, and due to an environmental load such as heat. Accordingly, a problem remains in which a liquid crystal display apparatus inevitably has a large outer dimension in the thickness direction of the entire apparatus. Therefore, it has been difficult to realize a liquid crystal display apparatus which maintains the display quality of a liquid crystal display apparatus, is inexpensive, and which can be downsized.

### SUMMARY OF THE INVENTION

It is an object of the present invention to provide a touch panel, a liquid crystal display apparatus and a method for manufacturing thereof, which enables prevention of interference fringes and sticking between the liquid crystal display panel and the touch panel without impairing the display performance of the liquid crystal display panel, and to reduce the thickness of the entire liquid crystal display apparatus.

In order to achieve the above described object, the touch panel relating to the present invention includes a dot spacer disposed on an inner transparent conductive film and is configured to be disposed on a display surface of a liquid crystal display panel via an air layer, wherein

an another dot spacer is disposed on a surface opposite to the display surface of the liquid crystal display panel at a position which does not overlap with the dot spacer within a predetermined viewing angle range in the display surface.

Further, the liquid crystal display apparatus relating to the present invention is configured such that a touch panel including a dot spacer disposed in an inner transparent conductive film is disposed on a display surface of a liquid crystal display panel via an air layer, wherein

an another dot spacer is disposed on the air layer at a position which does not overlap with the dot spacer within a predetermined viewing angle range in the display surface.

Further, the method for manufacturing a touch panel relating to the present invention comprises: for manufacturing a touch panel which includes a dot space disposed on an inner transparent conductive film and that is disposed on a display surface of a liquid crystal display panel via an air layer,

forming an another dot spacer at a position of a surface opposite to the display surface of the liquid crystal display panel, wherein the position does not overlap with the dot spacer within a predetermined viewing angle range in the display surface.

Further, the method for manufacturing the liquid crystal display apparatus relating to the present invention comprises: for manufacturing a liquid crystal display apparatus in which a touch panel having a dot spacer disposed on an inner transparent conductive film that is disposed on a display surface of a liquid crystal display panel via an air layer,

forming an another dot spacer at a position of the air layer, wherein the position does not overlap with the dot spacer within a predetermined viewing angle range on the display surface.

As so far described, according to the present invention, another dot spacer is disposed such that the liquid crystal display panel and the touch panel will not come into contact in the air layer by as an input operation such as using a touch panel, and is disposed so as not to be visually recognized in which the position of the another dot spacer is same as the position of the dot spacer of the touch panel. This configuration enables preventing interference fringes without impairing the display performance of the liquid crystal display panel and preventing sticking between the liquid crystal display panel and the touch panel. As a result of this, according to the present invention, it becomes possible to decrease the thickness of the air layer as well as to decrease the thickness of the touch panel. Therefore, according to the present invention, it is possible to decrease the outer dimension in the thickness direction of the entire liquid crystal display apparatus and thereby realize a liquid crystal display apparatus mounted with an inexpensive and high-quality touch panel.

### BRIEF DESCRIPTION OF THE DRAWINGS

FIG. 1 is a sectional view to show a first example of a liquid crystal display apparatus relating to the present invention;

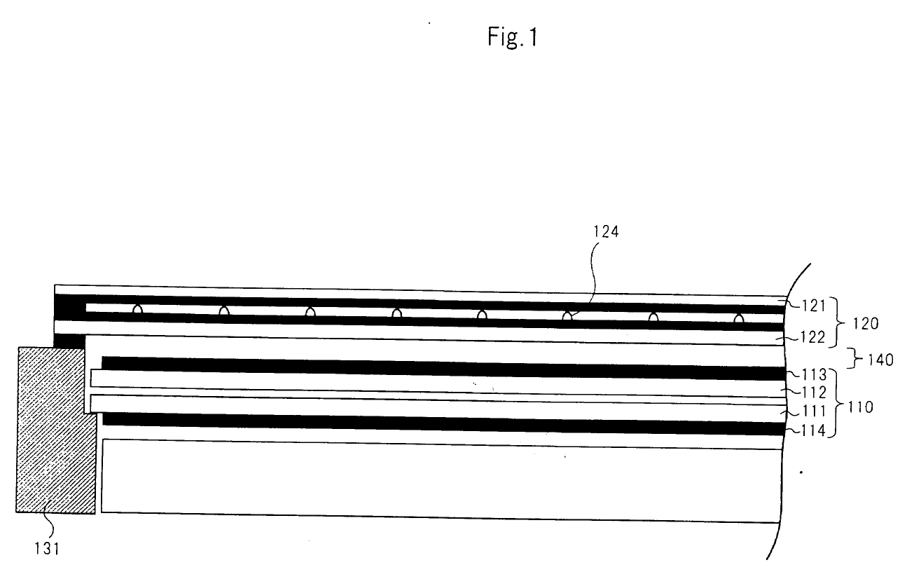

FIG. 2 is a sectional view to show a second example of the liquid crystal display apparatus relating to the present invention;

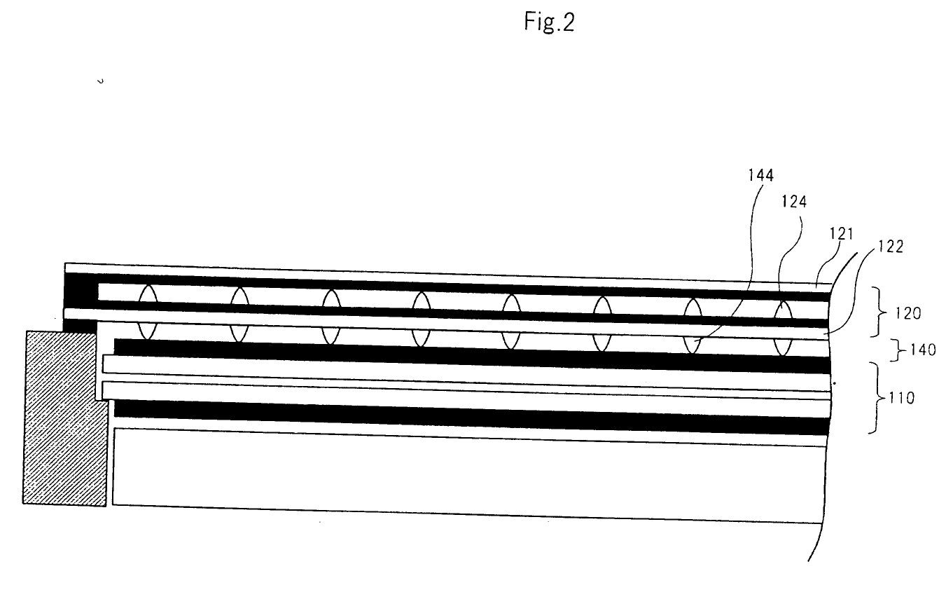

FIG. 3 is a sectional view to illustrate transmittance in the second example of the liquid crystal display apparatus relating to the present invention;

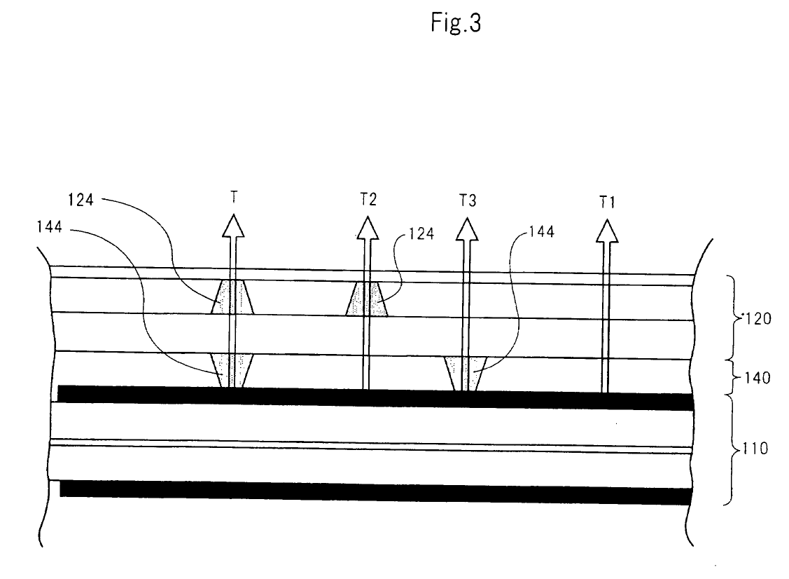

FIG. 4 is a sectional view to show a third example of the liquid crystal display apparatus relating to the present invention;

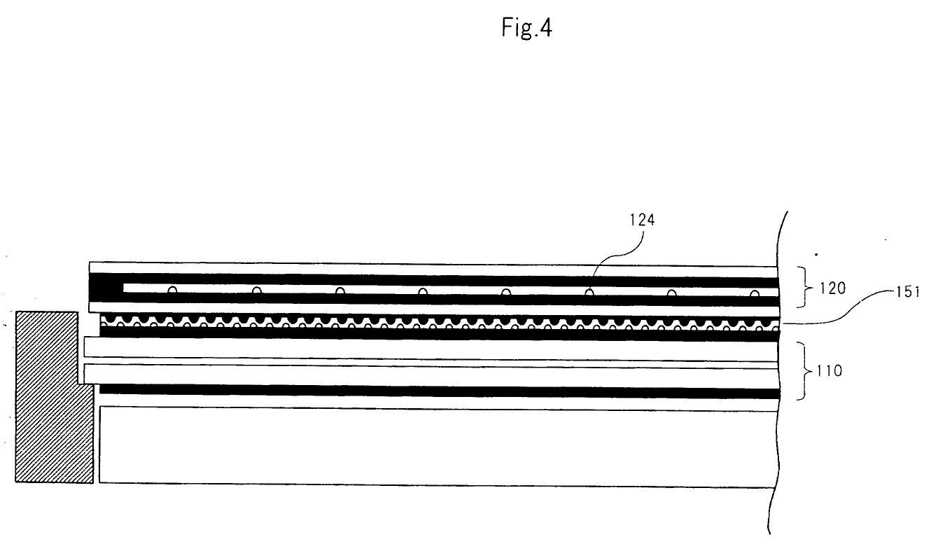

FIG. 5 is a sectional view to show a first exemplary embodiment;

FIG. 6A is a plan view to show the liquid crystal display apparatus of the first exemplary embodiment;

FIG. 6B is a plan view to show a reference example;

FIG. 7 is a sectional view to show in detail the principal part of the liquid crystal display apparatus of the first exemplary embodiment;

FIG. 8 is a sectional view to show the liquid crystal display apparatus of a second exemplary embodiment; and

FIG. 9 is a schematic view to show a printing apparatus used in the manufacturing method of the present exemplary embodiments.

### DETAILED DESCRIPTION OF THE EXEMPLARY EMBODIMENTS

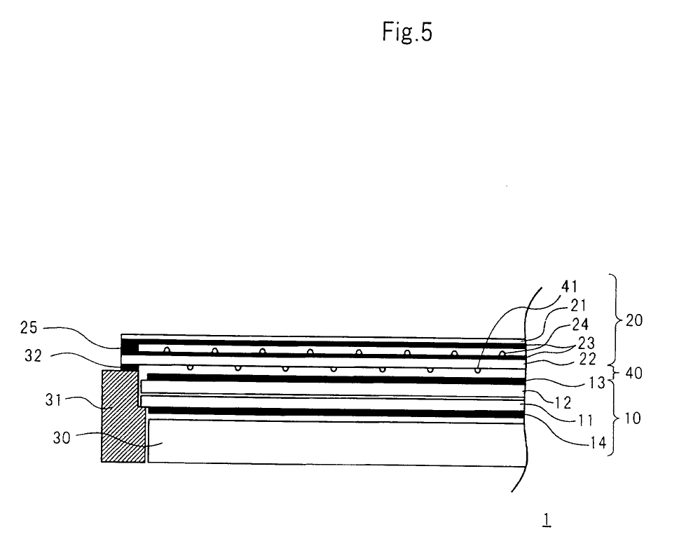

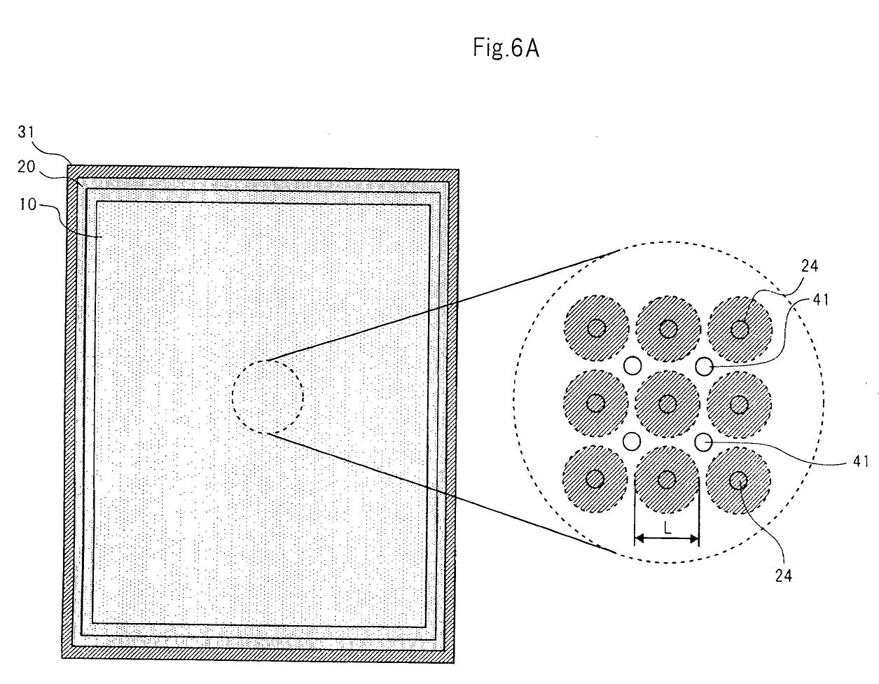

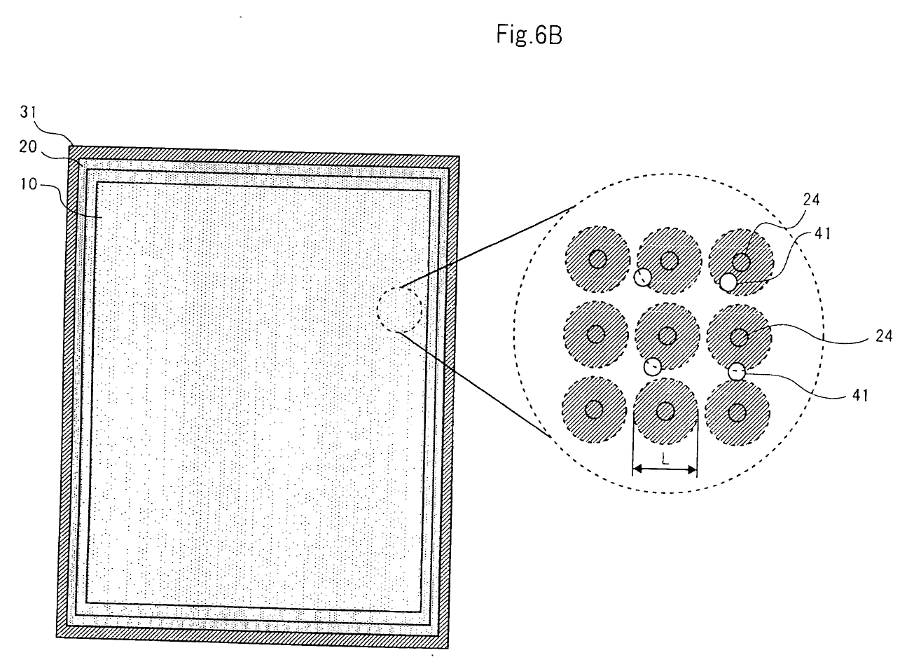

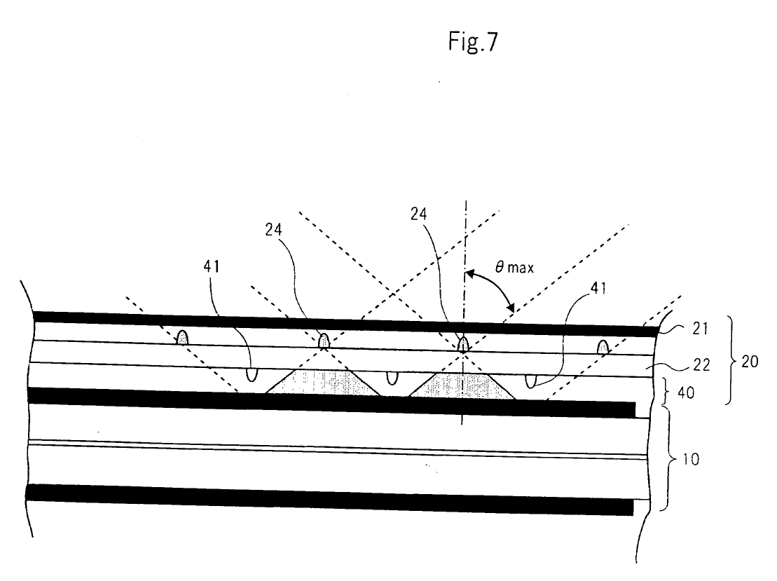

FIG. 5 shows a sectional view of the liquid crystal display apparatus of an exemplary embodiment; FIG. 6A shows a plan view of the liquid crystal display apparatus of an exemplary embodiment; and FIG. 6B shows a plan view of a reference example. FIG. 7 shows a detailed sectional view of the principal part of the liquid crystal display apparatus.

As shown in FIG. 5, liquid crystal display apparatus 1 of a first exemplary embodiment is configured to have liquid crystal display panel 10, and touch panel 20 which is disposed on the display surface of liquid crystal display panel 10 via air layer 40.

Liquid crystal display panel 10 is configured such that TFT substrate 11, which is disposed with a TFT pattern for driving a liquid crystal, and color filter substrate 12, which is formed such that an electrode layer and a color layer are mutually opposite each other, are disposed interposing a liquid crystal layer between substrates 11 and 12. TFT substrate 11 and color filter substrate 12 are attached with polarizing plate 13, 14 respectively.

Touch panel 20 is disposed such that upper substrate 21 which is formed on one side with transparent conductive film 23 as a position detection electrode, and lower substrate 22 which is similarly formed on one side with transparent conductive film 23, are disposed in such a way that transparent conductive films 23 are opposed to each other. Upper substrate 21 and lower substrate 22 are held with double-faced adhesive agent 25 disposed on the outer peripheral edge part of each substrate 21, 22. Liquid crystal display panel 10 has its outer peripheral part being placed directly on chassis frame 31. Touch panel 20 is placed on chassis frame 31 with double-faced adhesive agent 32 being interposed therebetween, where double-faced adhesive agent 32, which also performs a spacer function, is disposed on the outer peripheral edge part of touch panel 20 such that a fixed gap is maintained between touch panel 20 and chassis frame 31. Moreover, there is provided air layer 40 of a predetermined thickness between liquid crystal display panel 10 and touch panel 20. Further, backlight component 30 is disposed on the back face side of liquid crystal display panel 10 and backlight component 30 is fixed to chassis frame 31.

Further, in the present exemplary embodiment, other dot spacers 41 are disposed on the surface, which faces air layer 40, of lower substrate 22 of touch panel 20, that is, the surface opposite to the display surface of liquid crystal display panel 10. As shown in FIGS. 6A and 7, such dot spacers 41 are disposed at positions which do not coincide with those of dot spacers 24 disposed inside touch panel 20 within a normally used viewing angle range in liquid crystal display panel 10.

As to liquid crystal display apparatus 1 configured as described above, actions relating to the disposition of another dot spacer 41 will be described.

Now, as shown in FIG. 7, let a maximum angle in a viewing angle range, in which the visibility of liquid crystal display panel 10 is not impaired, be θmax centering on dot spacer 24 disposed inside touch panel 20. In this case, the range in which positional interference with dot spacer 24 inevitably takes place is given as within a circular region defined by a diameter L and is obtained by projecting a region surrounding dot spacer 24 which is determined depending on a predetermined viewing angle range onto a surface opposite to the display surface. Dot spacer 41 is disposed in the rear face of lower substrate 22 of touch panel 20 in such a way that there is a portion which does not overlap the circular region.

FIG. 6A shows a configuration in which the circular region of dot spacer 24 does not overlap with dot spacer 41 at all in the present exemplary embodiment, with dot spacer 41 being disposed outside the circular region. FIG. 7 is a sectional view to show the position of dot spacer 41 with respect to dot spacer 24. As a reference example, FIG. 6B shows a configuration example of a state in which the circular region of dot spacer 24 interferes with the position of part of dot spacer 41.

Diameter L of the circular region, when another dot spacer 41 is not disposed, is calculated by the following equation.

L=2×(thickness (mm) of lower substrate 22 of touch panel 20)×tan(θmax) (Equation)

As the result of another dot spacer 41 being disposed so as not overlap with the circular region of diameter L which satisfies the above equation, it becomes possible to prevent that dot spacers 24 and 41 from being viewed as overlapping each other within a viewing, angle range which is normally used, when the display area on the display surface of the liquid crystal display apparatus is viewed. Therefore, according to the present exemplary embodiment, compared with a configuration relating to the present invention in which dot spacer 41 is not provided in air layer 40, it becomes possible to prevent impairment of visibility, and also to prevent sticking between lower substrate 22 of touch panel 20 and the surface of liquid crystal display panel 10 as well as the occurrence of interference fringes.

As a specific exemplary embodiment, assuming that the viewing angle within which the display performance of a liquid crystal display panel will not be impaired corresponds to a case in which the contrast ratio of white and black intensities is not less than 10:1, when maximum angle θmax is supposed to be 45 degrees and when the thickness of lower substrate 22 of touch panel 20 is supposed to be 0.5 mm, diameter L of the circular region will be 1.0 mm. As shown in FIG. 6A, as the result of another dot spacer 41 being disposed such that there is a portion which does not overlap with the circular region, it is prevented that another dot spacer 41 and dot spacer 24 are prevented from being visually recognized as overlapping each other.

However, it is not necessary to have a configuration in which absolutely no overlapping takes place in the entire display area of the liquid crystal display apparatus. For example, a circular region of diameter L and dot spacer 41 may be overlapped in a portion of the region where demand for the magnitude of viewing angle range is relative low, such as upper and lower side edges and left and right side edges of a display area. When the use of a liquid crystal display apparatus is clearly defined such as when the above mentioned portion or the liquid crystal display apparatus is used in a fixed state in which the viewing angle characteristic in a fixed direction is always important, since a state in which dot spacers 24 and 41 are visually recognized as overlapped with each other as shown in FIG. 6B is relatively not likely to take place even when dot spacers 24 and 41 interfere with each other in the circular region of diameter L, there is low risk of visibility being impaired.

Moreover, the height of dot spacer 41 in the thickness direction of touch panel 20 is set to be smaller than the thickness of air layer 40 taking into consideration that an excessive load will not be applied such that display irregularities of liquid crystal display panel 10 will be reduced, which takes place when a pressing load is applied to the surface of upper substrate 21 of touch panel 20 by pressing the surface with a pen or a finger tip and thereby dot spacer 41 that is placed on lower substrate 22 of touch panel 20 locally presses the surface of liquid crystal display panel 10. Moreover, dot spacer 41 is formed like a cone having a circular base whose diameter is about 50 μm. Further, since dot spacer 41 is formed into a size equal to that of dot spacer 24 in touch panel 20 and since transmittance in the vertical direction (thickness direction of touch panel 20) is set to be equal to or not more than that of dot spacer 24 so that the base area of dot spacer 41 is smaller than the minimum pixel unit of liquid crystal display panel 10, the display quality will not be impaired.

As the result of providing dot spacer 41, when an input operation is performed onto the surface of upper substrate 21 of touch panel 20 with a pen or a finger tip, although touch panel 20 is deflected and lower substrate 22 of touch panel 20 and the surface of polarizing plate 13 of liquid crystal display panel 10 come closer to each other, the range where the surface of liquid crystal display panel 10 and the surface of lower substrate 22 of touch panel 20 come closer to each other in a plane is limited since dot spacer 41 is disposed on lower substrate 22 of touch panel 20. As the result of this, it becomes unlikely that the surface of liquid crystal display panel 10 and the surface of lower substrate 22 of touch panel 20 are always in close proximity or stick to each other, and thus it also becomes possible to suppress the occurrence of interference fringes.

Further, dot spacer 41 is formed of an acryl-based resin and the hardness of dot spacer 41 is adapted to be lower than the surface hardness of polarizing plate 13 of liquid crystal display panel 10. As the result, a press mark is prevented from being formed on the surface of polarizing plate 13 even when dot spacer 41 comes into contact with and presses the surface of polarizing plate 13. These effects enable decreasing the thickness of air layer 40 to a size at which interference fringes cannot take place even when the surface of liquid crystal display panel 10 and lower substrate 22 of touch panel 20 get closer to each other, thus enabling a reduction in the thickness dimension of entire liquid crystal display apparatus 100 thereby achieving thickness reduction.

Next, the method for manufacturing the liquid crystal display apparatus of exemplary embodiments will be described. Description will be made on a method of forming dot spacer 41 on the surface of lower substrate 22 of touch panel 20 in liquid crystal display apparatus 1 in the assembly process of liquid crystal display apparatus 100. As shown in FIG. 5, touch panel 20, which has been prepared as a component of liquid crystal display apparatus 1, is of an analog resistive film type in which upper substrate 21, which is formed on one side with transparent conductive film 23 as a position detection electrode, and in which lower substrate 22, which is similarly formed with transparent conductive film 23, are disposed such that transparent conductive films 23 are opposite each other and are held by double-faced adhesive agent 25 provided on the peripheral edge part of each substrate 21, 22. There are disposed at a pitch of 3 mm on transparent conductive film 23 of lower substrate 22, dot spacers 24 which is formed into sizes in which the diameter of the base is 50 μm and in which the height is 50 μm, using, for example, an acryl-based resin. Lower substrate 22 of touch panel 20 is formed of, for example, silica glass to have a thickness of 0.5 mm. Dot spacer 41 is provided by being printed on the surface of lower substrate 22 of touch panel 20.

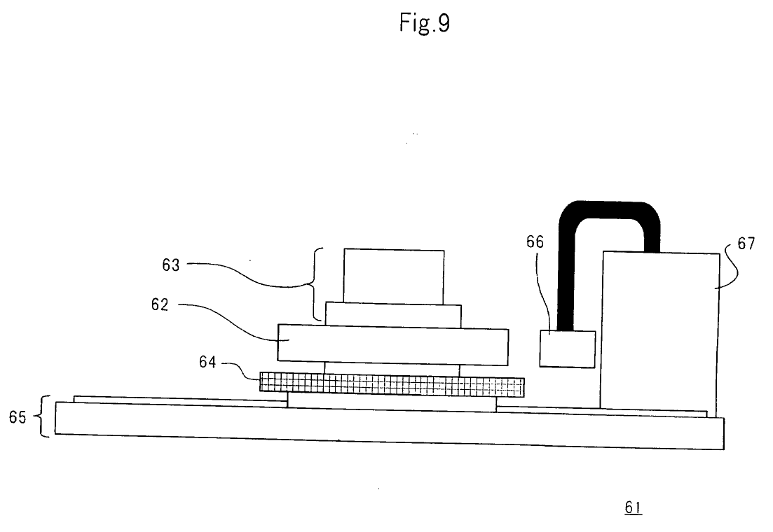

Dot spacer 41 is formed by printing by use of, for example, an inkjet-type printing apparatus. For example, as shown in FIG. 9, printing apparatus 61 is configured to include nozzle part 62 for ejecting a resin material to form dot spacer 41, nozzle driving part 63 for driving nozzle part 62, driving stage 64 on which touch panel 20 is placed, stage driving part 65 for driving driving stage 64, UV (ultraviolet ray) irradiation part 66 for irradiating touch panel 20 on which dot spacer 41 has been printed with an ultraviolet ray, and control part 67 for controlling nozzle driving part 63, stage driving part 65, and UV irradiation part 66 respectively.

First, touch panel 20 is placed at a fixed position of driving stage 64 of printing apparatus 61 with the printing surface facing upward. Driving stage 64 and nozzle part 62 are moved to a preprogrammed position based on a command to start the print operation which starts the printing of dot spacer 41 on the surface of lower substrate 22 of touch panel 20. A colorless and transparent acryl-based resin having ultraviolet curability is used as the resin material that is to be ejected from nozzle part 62. Because only dot spacer 41 is being printed, it takes time until dot spacer 41 hardens, and because the printed shape will change before dot spacer 41 dries, dot spacer 41 is irradiated with an ultraviolet ray and is thereby caused to adhere to the glass substrate.

Driving stage 64, on which touch panel 20 printed with dot spacer 41 is placed, is moved to a position opposite to UV irradiation part 66 so that the print surface of touch panel 20 is irradiated with an ultraviolet ray. UV irradiation part 66 is of a type which can irradiate light having a wavelength of 185 nm to 405 nm with ultraviolet ray irradiation, and there is concern that the temperature of touch panel 20 may rise due to the irradiation of light. For that reason, an LED (light emitting diode) which is comparatively able to suppress the temperature rise of the object to be irradiated is used as the light source. By irradiating the resin material ejected onto the print surface with an ultraviolet ray which is set to have an irradiation intensity of 300 mW/cm², the resin material is hardened within about 10 seconds thereby completing the printing process. Then, touch panel 20, which has been formed with dot spacer 41, is removed from driving stage 64. By mounting touch panel 20 printed with dot spacer 41 onto a liquid crystal display apparatus which is halfway through assembling and which is in a state prior to the start of the process of mounting touch panel 20, touch-panel equipped liquid crystal display apparatus 100 is completed.

It is noted that although a configuration in which dot spacer 41 is formed by an inkjet-type printing method is adopted, it may of course be formed by for example, screen printing, photolithography, and the like.

As so far described, liquid crystal display apparatus 1 is configured such that another dot spacer 41, whose size is minute, is disposed in air layer 40, which is provided between liquid crystal display panel 10 and touch panel 20, at a position which is different from that of dot spacer 24 of touch panel 20 within a predetermined viewing angle range normally used for the display of liquid crystal display panel 10. Since, with another dot spacer 41 being disposed in this way, positional interference between dot spacers 24 and 41 does not take place, it becomes possible to prevent a direct contact between the surface of liquid crystal display panel 10 and the rear face of touch panel 20 without highlighting the existence of the dot spacers, thereby constantly keeping a fixed spacing even when liquid crystal display panel 10 and touch panel 20 come close to each other. In this respect, liquid crystal display apparatus 1 has an advantage in that it can maintain display performance and inhibit the occurrence of interference fringes thus further preventing a decline in optical performance. Therefore, according to liquid crystal display apparatus 1, it becomes possible to decrease the thickness of air layer 40 and thereby reduce the outer dimension in the thickness direction of entire liquid crystal display apparatus 1 thereby, achieving thickness reduction and weight reduction.

### Second Exemplary Embodiment

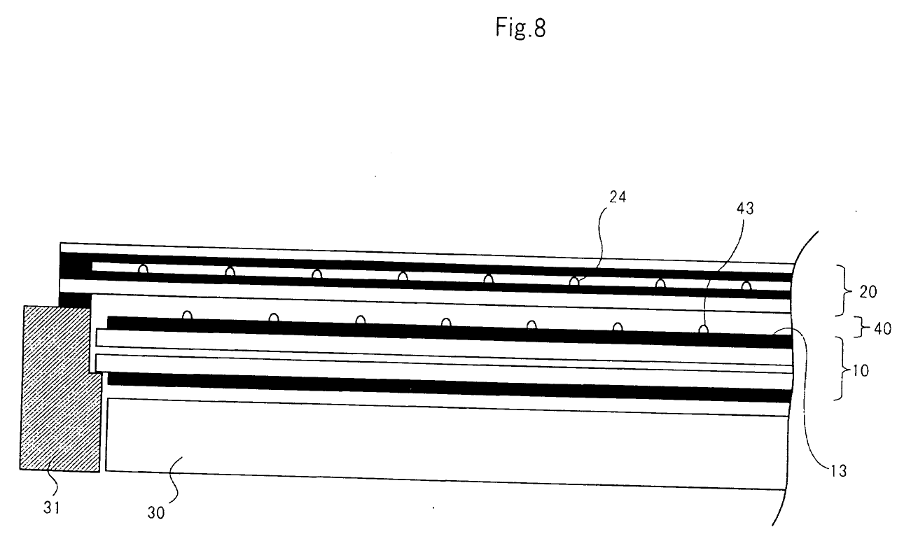

FIG. 8 shows the liquid crystal display apparatus of a second exemplary embodiment. The present exemplary embodiment is different from the first exemplary embodiment in that dot spacer 43 is formed on the surface of polarizing plate 13 included in color filter substrate 12 which makes up the liquid crystal display panel.

As shown in FIG. 8, projection-like dot spacers 43 of a predetermined size are formed in a regular arrangement on polarizing plate 13 on color filter substrate 12 by use of a printing and coating method onto the surface of polarizing plate 13 which is generally practiced in the manufacturing process of polarizing plate 13. Subsequently, polarizing plate 13 on which dot spacers 43 have been made is pasted onto color filter substrate 12 of liquid crystal display panel 10 to make up liquid crystal display panel 10. At this moment, dot spacer 43 that is to be formed on polarizing plate 13 is defined and processed so as to be disposed at a position where interference with dot spacer 24 in touch panel 20 can be avoided.

Further, the design must be such that when the positional accuracy in pasting polarizing plate 13 with respect to liquid crystal display panel 10 is set to be plus and minus 0.3 mm for both the up-and-down and left-and-right directions, the mounting position of touch panel 20 with respect to the liquid crystal display apparatus can be adjusted by plus and minus 0.3 mm in both the up-and-down and left-and-right directions. In practice, since dot spacer 43 formed on the surface of polarizing plate 13 and dot spacer 24 of touch panel 20 are defined to be in such a position that they do not overlap with each other in position, transmittance decline is suppressed to a minimum and therefore display performance will not be affected by the level of incidence in which interference occurs by partial overlapping of dot spacer 43 and dot spacer 24.

It is noted that electronic equipment to which the present invention is preferably applied includes: for example, liquid crystal display apparatuses equipped with a touch panel, for example, a liquid crystal display apparatus which is equipped with a touch panel and which has a telephone function as well; portable liquid crystal display apparatuses such as PDAs and mobile computers; car navigation systems as well as liquid crystal display apparatuses which involve relatively frequent input operations such as POS terminals at convenience stores, ATMs and ticket machines.

While the invention has been shown and described with particular reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2008-53330, filed on Mar. 4, 2008, the disclosure of which is incorporated herein in its entirety by reference.

What is claimed is:

1. A touch panel including a dot spacer disposed on an inner transparent conductive film and configured to be disposed on a display surface of a liquid crystal display panel via an air layer, wherein
an another dot spacer is disposed on a surface opposite to said display surface of said liquid crystal display panel at a position which does not overlap with said dot spacer within a predetermined viewing angle range in said display surface.

2. The touch panel according to claim 1, wherein
said another dot spacer has a height smaller than the thickness of said air layer and a base area smaller than a minimum pixel unit of said liquid crystal display panel.

3. The touch panel according to claim 1, wherein
the transmittance of said another dot spacer is not more than that of said dot spacer.

4. A liquid crystal display apparatus configured such that a touch panel including a dot spacer disposed on an inner transparent conductive film is disposed on a display surface via an air layer, wherein
an another dot spacer is disposed on said air layer at a position which does not overlap with said dot spacer within a predetermined viewing angle range.

5. The liquid crystal display apparatus according to claim 4, wherein
said another dot spacer is disposed outside a circular region, said circular region being a projected region, where a region surrounding said dot spacer, that is determined depending on said predetermined viewing angle range, is projected onto said display surface.

6. The liquid crystal display apparatus according to claim 4, wherein
said another dot spacer is disposed on said display surface of said liquid crystal display panel.

7. The liquid crystal display apparatus according to claim 6, wherein
said liquid crystal display panel includes a polarizing plate disposed at a position opposite to said touch panel, and
said another dot spacer is disposed on a surface of a polarizing plate that is disposed on a surface opposite to said touch panel.

8. The liquid crystal display apparatus according to claim 4, wherein
said touch panel includes a substrate formed with said transparent conductive film, and
said another dot spacer is disposed on a surface opposite to said display surface in said substrate.

9. The liquid crystal display apparatus according to claim 8, wherein
said liquid crystal display panel includes a polarizing plate disposed at a position opposite to said touch panel, and
said another dot spacer is made of a material having a hardness lower than the surface hardness of said polarizing plate.

10. The liquid crystal display apparatus according to claim 4, wherein
said another dot spacer has a height smaller than the thickness of said air layer, and a base area smaller than a minimum pixel unit.

11. The liquid crystal display apparatus according to claim 4, wherein
the transmittance of said another dot spacer is not greater than that of said dot spacer.

12. A method for manufacturing a touch panel comprising:
for manufacturing a touch panel which includes a dot spacer that is disposed on an inner transparent conductive film and that is disposed on a display surface of a liquid crystal display panel via an air layer,
forming an another dot spacer at a position of a surface opposite to said display surface of said liquid crystal display panel, wherein said position does not overlap with said dot spacer within a predetermined viewing angle range in said display surface.

13. The method for manufacturing a touch panel according to claim 12, wherein
in said forming, said another dot spacer is formed outside a circular region, said circular region being a projected region, where a region surrounding said dot spacer, that is determined depending on said predetermined viewing angle range, is projected onto a surface opposite to said display surface.

14. The method for manufacturing a touch panel according to claim 12, wherein
said another dot spacer is formed by using screen printing or photolithography.

15. A method for manufacturing a liquid crystal display apparatus comprising:
for manufacturing a liquid crystal display apparatus in which a touch panel having a dot spacer disposed on an inner transparent conductive film is disposed on a display surface via an air layer,
forming an another dot spacer at a position of said air layer, wherein said position does not overlap with said dot spacer within a predetermined viewing angle range.

16. The method for manufacturing a liquid crystal display apparatus according to claim 15, wherein
in said forming, said another dot spacer is formed outside a circular region, said circular region being a projected region, where a region surrounding said dot spacer, that is determined depending on said predetermined viewing angle range, is projected onto said display surface.

17. The method for manufacturing a liquid crystal display apparatus according to claim 15, wherein
in said forming, said another dot spacer is formed on said display surface of said liquid crystal display panel.

18. The method for manufacturing a liquid crystal display apparatus according to claim 15, wherein
in said forming, said another dot spacer is formed on a surface of said touch panel opposite to said display surface of said liquid crystal display panel.

19. The method for manufacturing a liquid crystal display apparatus according to claim 15, wherein
said another dot spacer is formed by using screen printing or photolithography.
